(19) United States
(12) Patent Application Publication
(10) Pub. No.: US 2024/0227715 A1
(43) Pub. Date: Jul. 11, 2024

(54) INSERT MOLDED ENERGY ABSORPTION BRACKET

(71) Applicant: Ford Global Technologies, LLC, Dearborn, MI (US)

(72) Inventors: Christopher Robert Tilli, Brighton, MI (US); Jay Douglas Blackson, Dryden, MI (US); Timothy Barr, Clinton Township, MI (US)

(73) Assignee: Ford Global Technologies, LLC, Dearborn, MI (US)

(21) Appl. No.: 18/093,418

(22) Filed: Jan. 5, 2023

(51) Int. Cl. B60R 21/04; B60R 13/02

(52) U.S. Cl. CPC B60R 21/04; B60R 13/02; B60R 2021/0407

(57) ABSTRACT

A trim assembly comprising a tube and a trim cover. The trim cover has an inner surface and an outer surface. The trim assembly further comprising an upper portion coupled with the tube and a lower portion. The trim assembly further comprising an energy absorption bracket insert molded into the trim cover The energy absorption bracket has a convex surface and a concave surface. The trim assembly further comprising an air curtain disposed between the tube and the energy absorption bracket.

### FIELD OF THE DISCLOSURE

The present disclosure generally relates to an energy absorption bracket for an interior of a vehicle. More specifically, the disclosure relates to an energy absorption bracket that is insert molded into a trim of the interior of the vehicle.

### BACKGROUND OF THE DISCLOSURE

Vehicles often include brackets directed adhered to a body of the vehicle. These vehicles often include interior trim covering the body of the vehicle.

### SUMMARY OF THE DISCLOSURE

According to a first aspect of the present disclosure, a trim assembly for a vehicle comprises a tube and a trim cover coupled with the tube. The trim assembly further comprising an air curtain disposed between the tube and the trim cover. The trim assembly further comprising a bracket insert molded into the trim cover. The bracket is spaced from the tube and the air curtain.

Embodiments of the first aspect of the present disclosure can include any one or a combination of the following features:
the trim cover further comprises an inner surface; and an outer surface, wherein the bracket is insert molded between the inner surface and the outer surface;
the trim cover is concave toward the tube, and wherein the bracket is concave toward the tube;
the trim assembly operates between an original position, a flattened position, and a deployed position;
the trim cover is made from a polymeric material, wherein the bracket is made from a first metal material, and wherein the tube is made from a second metal material;
the bracket further extends linearly in a lateral direction, and wherein the bracket extends curvedly in a vertical direction;
the bracket is partially exposed between the trim cover and the tube;
the trim cover further comprises a plurality of mold slots, and wherein a peripheral edge of the bracket is insert molded into the plurality of mold slots;
the peripheral edge of the bracket is partially exposed between the plurality of mold slots;
the plurality of mold slots protrudes from the trim body toward the tube in the original position and the flattened position;
a convex surface of the bracket interfaces with an inner surface of the trim cover;
the trim cover further includes an upper portion coupled with the tube and a lower portion cantilevered from the tube;
the air curtain is further disposed between the tube and the bracket; and
the trim cover has a first thickness, wherein the bracket has a second thickness, and wherein the first thickness is greater than the second thickness.

According to a second aspect of the present disclosure, a trim assembly comprising a tube and a trim cover. The trim cover has an inner surface and an outer surface. The trim assembly further comprising an upper portion coupled with the tube and a lower portion. The trim assembly further comprising an energy absorption bracket insert molded into the trim cover. The energy absorption bracket has a convex surface and a concave surface. The trim assembly further comprising an air curtain disposed between the tube and the energy absorption bracket.

Embodiments of the second aspect of the present disclosure can include any one or a combination of the following features:
the convex surface and the concave surface are both disposed between the inner surface and the outer surface;
the energy absorption bracket is insert molded into the trim cover via at least one mold slot; and
the trim cover has a first thickness, wherein the bracket has a second thickness, and wherein the first thickness is greater than the second thickness.

According to a third aspect of the present disclosure, a trim assembly comprising a tube that defines a frame of the vehicle and a trim cover comprising an inner surface concave toward the tube. The trim cover further comprising an outer surface convex toward an interior of the vehicle and an upper portion. The upper portion is coupled with the tube. The trim cover further comprising a lower portion. The lower portion is cantilevered from the tube. The trim assembly further comprising an energy absorption bracket insert molded into the trim cover. The energy absorption bracket comprising a concave surface facing the tube. The concave surface is at least partially covered by the trim cover. The energy absorption bracket also comprising a convex surface facing the interior of the vehicle. The convex surface is at least partially covered by the trim cover. The energy absorption bracket further comprising a peripheral edge. The trim assembly further comprising an air curtain disposed between the energy absorption bracket and the tube.

Embodiments of a third aspect of the present disclosure can include the following features:
the trim cover further comprises mold slots protruding toward the tube, wherein the peripheral edge of the energy absorption bracket is insert molded into the mold slots, and the bracket is at least partially exposed to the air curtain and the tube.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a rear perspective view of a trim cover and an energy absorption bracket partially disposed within the trim cover;

FIG. 2 is front perspective view a trim cover and an energy absorption bracket partially disposed within the trim cover;

FIG. 3 is a lateral view of a trim cover, an energy absorption bracket partially disposed within the trim cover, and an air curtain;

FIG. 4 is an isometric view of a trim assembly;

FIG. 5A is rear isometric view of a trim assembly in an original position;

FIG. 5B is rear isometric view of a trim assembly in a flattened position;

FIG. 5C is rear isometric view of a trim assembly transitioning toward a deployed position;

FIG. 6 is a bottom perspective view of a trim assembly;

FIG. 7 is a lateral view of a trim cover and a partially exposed energy absorption bracket partially disposed within mold slots of the trim cover; and

FIG. 8 is a rear perspective view of a trim cover and a partially exposed energy absorption bracket partially disposed within mold slots of the trim cover.

### DETAILED DESCRIPTION OF THE PREFERRED EMBODIMENTS

As required, detailed embodiments of the present disclosure are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

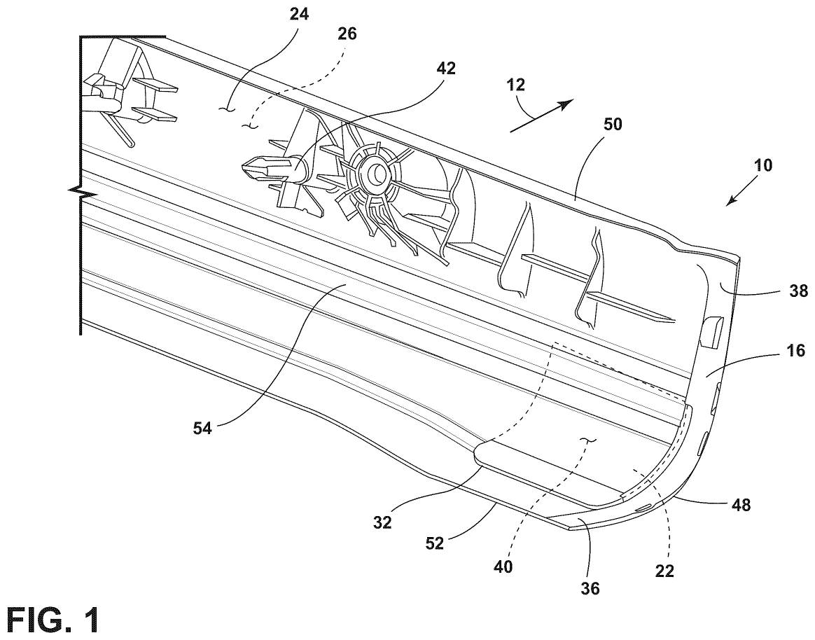

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of apparatus components related to a trim assembly having an insert molded energy absorption bracket. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

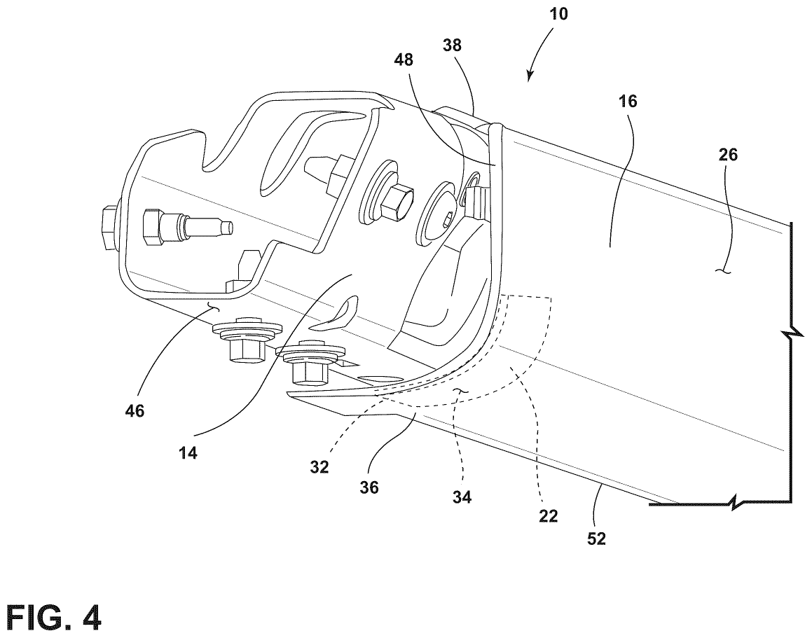

With reference to FIGS. 1-8, an embodiment of a trim assembly 10 for a vehicle 12 is provided which includes a tube 14 and a trim cover 16 which serves as a side rail trim is coupled with the tube 14. The trim assembly 10 further has an air curtain 20 disposed between the tube 14 and the trim cover 16. The trim assembly further includes a bracket 22 or an energy absorption bracket that is insert molded into the trim cover 16. The bracket 22 is spaced from the tube 14 and the air curtain 20.

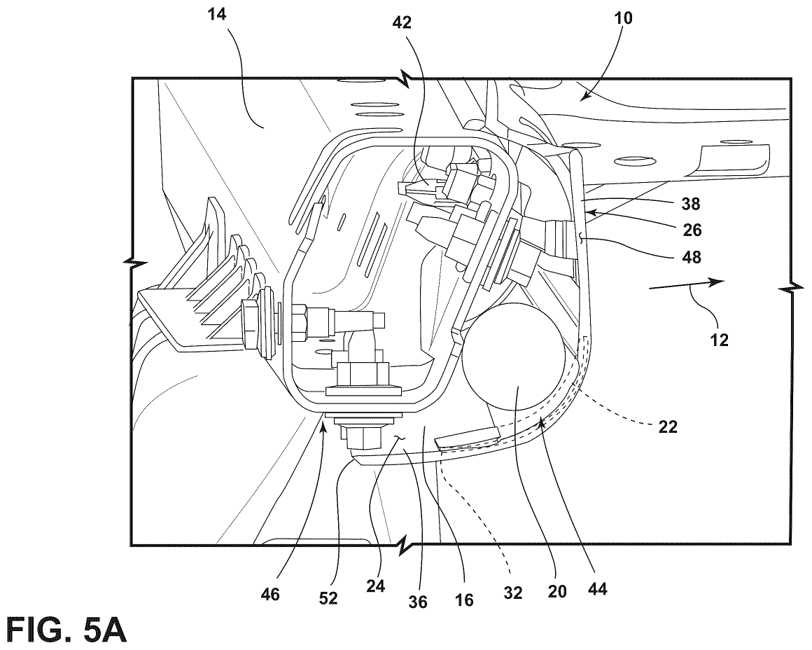

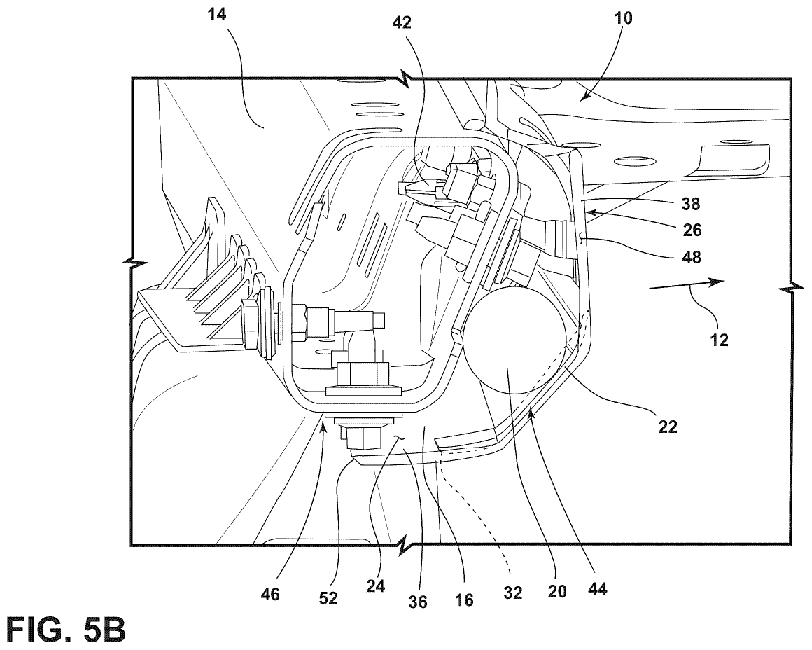

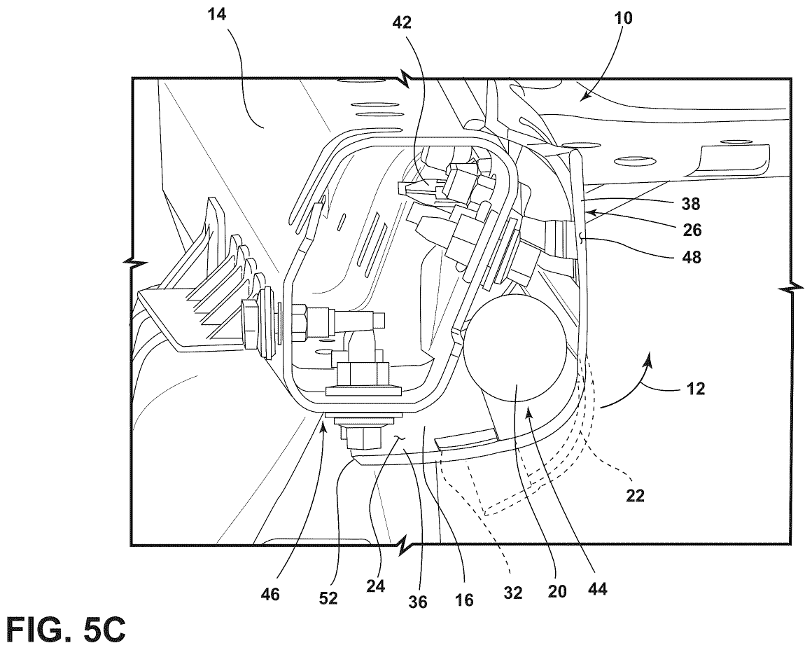

The trim cover 16 may further include an inner surface 24 and an outer surface 26. The bracket 22 may be insert molded between the inner surface 24 and the outer surface 26. The trim cover 16 may be concave toward the tube 14. The bracket 22 may be concave toward the tube 14. The trim assembly 10 may operate between an original position (better seen in FIG. 5A), a flattened position (better seen in FIG. 5B), and a deployed position (better seen in FIG. 5C). The trim cover 16 may be made from a polymeric material such as polypropylene, for example. The bracket 22 may be made from a first metal material (e.g., steel, aluminum, or another similar metal or alloy). The tube 14 may be made from a second metal material (e.g., steel, aluminum, or another similar metal or alloy).

The bracket 22 may extend linearly in a lateral direction and may extend curvedly in a vertical direction. The bracket 22 may be partially exposed between the trim cover 16 and the tube 14. The trim cover 16 may further include a plurality of mold slots 30. A peripheral edge 32 of the bracket 22 may be insert molded into the plurality of mold slots 30. The peripheral edge 32 of the bracket 22 may be partially exposed between the plurality of mold slots 30. The plurality of mold slots 30 may protrude from the trim body 18 toward the tube 14 in the original position and the flattened position. A convex surface 34 of the bracket 22 may interface with an inner surface 24 of the trim cover 16. The trim cover 16 further includes an upper portion 38 coupled with the tube 14 and a lower portion 36 cantilevered from the tube 14. The air curtain 20 is further disposed between the tube 14 and the bracket 22. The trim cover 16 has a first thickness, T1. The bracket 22 has a second thickness T2, and the first thickness T1 may be greater than the second thickness T2, according to one example. According to other examples it is contemplated that the second thickness T2 may be the same or greater than the first thickness T1.

The trim assembly 10 includes a tube 14 and a trim cover 16. The trim cover 16 has an inner surface 24 and an outer surface 26. The trim assembly 10 further includes an upper portion 38 coupled with the tube 14 and a lower portion 36. The trim assembly 10 further has an energy absorption bracket 22 inserted molded into the trim cover 16. The energy absorption bracket 22 has a convex surface 34 and a concave surface 40. The trim assembly 10 further includes an air curtain 20 disposed between the tube 14 and the energy absorption bracket 22.

The convex surface 34 and the concave surface 40 may both be disposed between the inner surface 24 and the outer surface 26. The energy absorption bracket may be insert molded into the trim cover 16 via at least one mold slot or a plurality of mold slots 30. The trim cover 16 has a first thickness T1. The bracket 22 has a second thickness T2. The first thickness T1 is greater than the second thickness T2, according to one example. According to other examples it is contemplated that the second thickness T2 may be the same or greater than the first thickness T1.

With further refence to FIGS. 1-8, a trim assembly 10 is provided that includes a tube 14 that defines a frame of the vehicle 12 and a trim cover 16 comprising an inner surface 24 concave toward the tube 14. The trim cover 16 further includes an outer surface 26 convex toward an interior of the vehicle 12 and an upper portion 38. The upper portion 38 is coupled with the tube 14. The trim cover 16 further has a lower portion 36. The lower portion 36 is cantilevered from the tube 14. The trim assembly 10 further has an energy absorption bracket 22 insert molded into the trim cover 16. The energy absorption bracket 22 has a concave surface 40 facing the tube 14. The concave surface 40 is at least partially covered by the trim cover 16. The energy absorption bracket also includes a convex surface 34 facing the interior of the vehicle 12. The convex surface 34 is at least partially covered by the trim cover 16. The energy absorption bracket 22 further includes a peripheral edge 32. The trim assembly 10 further includes an air curtain 20 disposed between the energy absorption bracket 22 and the tube 14.

With further reference to FIGS. 1-8, the trim cover 16 may further include mold slots 30 protruding toward the tube 14. The peripheral edge 32 of the energy absorption bracket 22 may be insert molded into the mold slots 30. The bracket 22 may be at least partially exposed to the air curtain 20 and the tube 14.

With reference to FIG. 1, a rear view of the trim cover 16 is shown. The energy absorption bracket 22 can be seen at least partially disposed inside of the trim cover 16 between the inner surface 24 and the outer surface 26 of the trim cover 16. The trim cover 16 extends linearly in lateral direction. The energy absorption bracket 22 also extends linearly in the lateral direction. The trim cover 16 extends linearly in the vertical direction. The trim cover 16 also extends curvedly toward the tube 14 (not shown), then linearly toward the tube 14 (not shown). The energy absorption bracket 22, therefore, extends curvedly in the vertical direction toward the tube 14 (not shown). The energy absorption bracket 22 and the trim cover 16 may curve to the same, or to substantially the same, degree.

Still referring to FIG. 1, the energy absorption bracket 22 may extend at least partially linearly in the vertical direction and at least partially linearly toward the tube 14 (not shown). A coupling mechanism 42 (e.g., a fastener as shown) is disposed on the upper portion 38 of the trim cover 16 on the inner surface 24. The coupling mechanism 42 couples with the tube (not shown). The energy absorption bracket 22 may extend curvedly in a vertical direction less than the trim cover 16 extends curvedly in the vertical direction. The energy absorption bracket 22 may extend less linearly in the lateral direction than the trim cover 16 extends linearly in the lateral direction such that the trim cover 16 extends past the peripheral edge 32 of the energy absorption bracket 22. Additionally, or alternatively, the peripheral edge 32 of the energy absorption bracket 22 may be partially exposed (e.g., solid-lined portion of the energy absorption bracket 22, as shown). The inner surface 24 of the trim cover 16 may define recessed grooves 54.

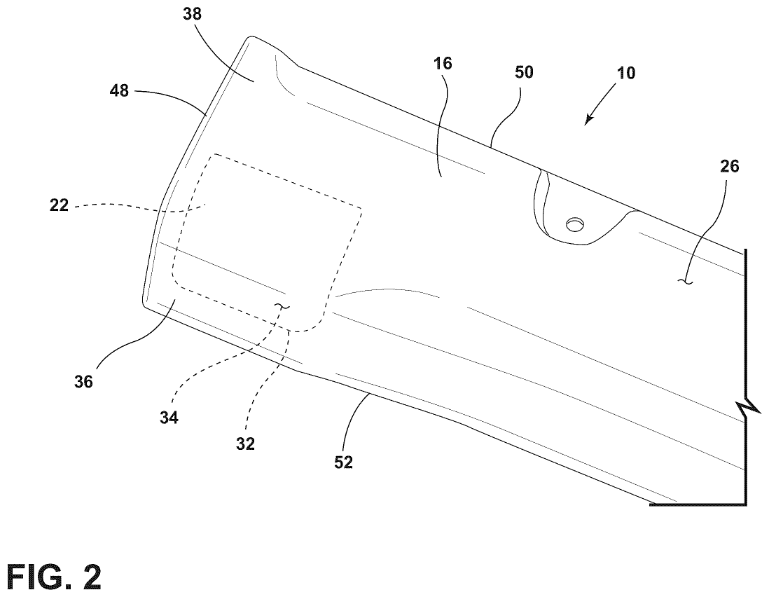

With reference to FIG. 2, a front view of the trim cover 16 is shown with the energy absorption bracket 22 disposed therein. An occupant of the vehicle 12 may observe and interact with the outer surface 26 of the trim cover 16. The outer surface 26 of the trim cover 16 may be between the convex surface 34 of the energy absorption bracket 22 and the occupant.

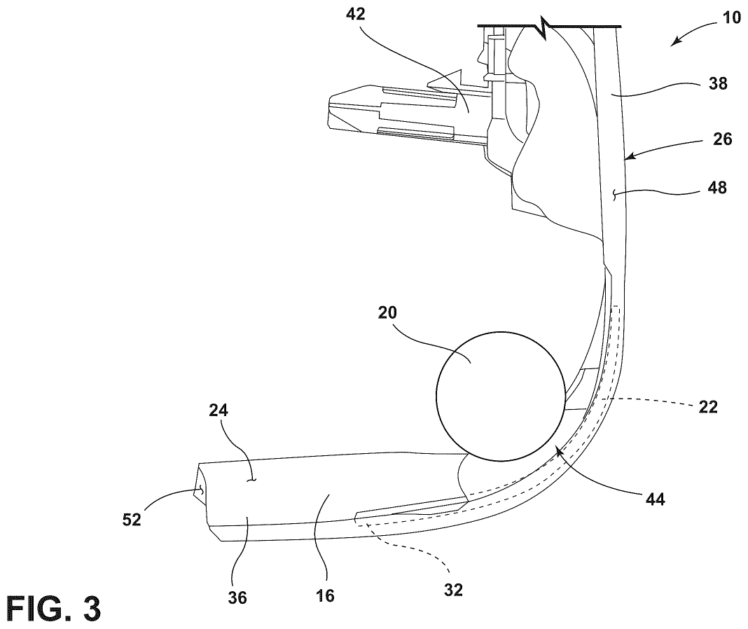

With reference to FIG. 3, the peripheral edge 32 of the energy absorption bracket 22 may be insert molded into the trim cover 16 such that the peripheral edge 32 is disposed within the trim cover 16. The outer surface 26 of the trim cover 16 may be convex just as the convex surface 34 of the energy absorption bracket 22 is convex. The inner surface 24 of the trim cover 16 may be concave just as the concave surface 40 of the energy absorption bracket 22 is concave. The inner surface 24 of the trim cover 16 and the concave surface 40 of the energy absorption bracket 22 may at least partially surround the air curtain 20. The energy absorption bracket 22 and the trim cover 16 are spaced from the air curtain 20. The air curtain 20 may be disposed toward an apex 44 of both the inner surface 24 and the concave surface 40.

With reference to FIG. 3, the coupling mechanism 42 which serves as a locator is disposed on the upper portion 38 of the inner surface 24 of the trim cover 16 is coupled with the tube 14. The lower portion 36 of the trim cover 16 is cantilevered from the tube 14, thus the energy absorption bracket 22 is spaced from the tube 14. The trim cover 16 and the energy absorption bracket 22 at least partially surround the tube 14 in the lateral direction and the vertical direction. The trim cover 16 and the energy absorption bracket 22 curve toward the tube 14 such that trim cover 16 and the energy absorption bracket 22 at least partially cover a bottom side 46 of the tube 14.

With reference to FIG. 5A, the trim assembly 10 can be seen in the original position. The air curtain 20 is disposed between the tube 14 and the energy absorption bracket 22 as well as the trim cover 16. More specifically the air curtain 20 is disposed between the tube 14 and the concave surface 40 of the energy absorption bracket 22, as well as the inner surface 24 of the trim cover 16. At least one of the mold slots 30 may retain the peripheral edge 32 of the energy absorption bracket 22 disposed within the mold slot.

With reference to FIG. 5B, the trim assembly 10 is shown in the flattened position. In the flattened position, the concave surface 40 of the energy absorption bracket 22 flattens. The convex surface 34 of the energy absorption bracket 22 also flattens toward the tube 14 (not shown). The inner surface 24 of the trim cover 16 and the outer surface 26 of the trim cover 16 also flatten as the trim assembly 10 transitions from the original position toward the flattened position. In the flattened position, the apex 44 of the energy absorption bracket 22 and the trim cover 16 translates toward being linearly aligned with the rest of the elements of the energy absorption bracket 22 and the trim cover 16. The energy absorption bracket 22 is insert molded within the trim cover 16 in the original position, the flattened position, and therebetween. With reference to FIG. 5C, an arrow is shown to demonstrate one example of how the trim cover 16, and thus the energy absorption bracket 22, can move relative to the air curtain 20 and the tube 14 (e.g., pivots). Additionally, or alternatively, the trim cover 16 and thus the energy absorption bracket 22 may translate away from the air curtain 20 and the tube or slide past the air curtain 20 and the tube 14. The energy absorption bracket 22 is remains inserted molded within the trim cover 16 in the original position, the flattened position, the deployed position, and therebetween.

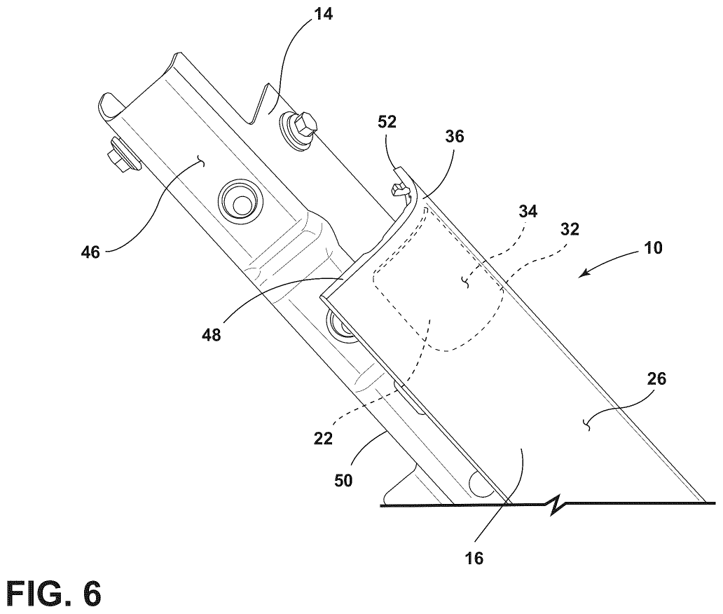

With reference to FIG. 6, the peripheral edge 32 of the energy absorption bracket 22 may correspond with a lateral edge 48 of the trim cover 16 and an upper edge 50 of the upper portion 38 of the trim cover 16, as well as a lower edge 52 of the lower portion 36 of the trim cover 16.

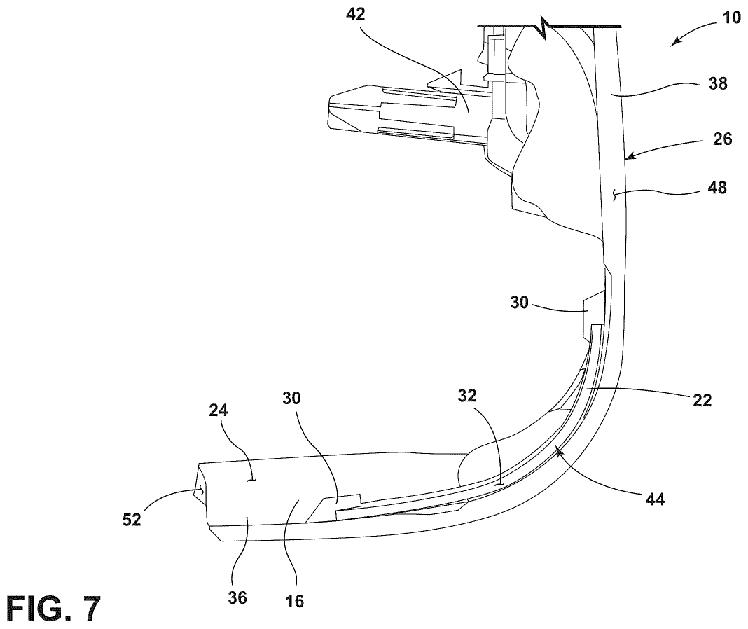

With reference to FIG. 7, the plurality of mold slots 30 disposed on the trim cover 16 may extend from the inner surface 24 of the trim cover 16 toward the tube 14 (not shown) in the original position and the flattened position. The energy absorption bracket 22 may be exposed between the plurality of the mold slots 30. The peripheral edge 32 of the energy absorption bracket 22 may also be exposed between the plurality of mold slots 30. Each of the mold slots 30 protrude from the inner surface 24 and toward the other of the plurality of mold slots 30. Additionally, or alternatively, the energy absorption bracket 22 may define apertures and or recesses such that the plurality of mold slots 30 may protrude from the inner surface 24 of the trim cover 16 and away from the other of the plurality of mold slots 30.

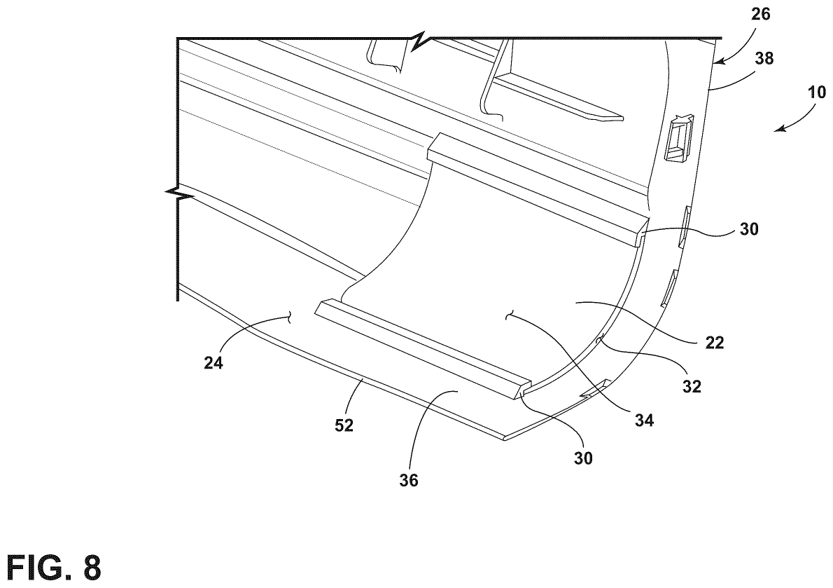

With reference to FIG. 8, one the mold slots of the plurality of mold slots 30 may be oriented on the inner surface 24 of the trim cover 16 such that the other mold slot of the plurality of mold slots 30 is oriented mirrored and rotated from the one mold slot of the plurality of mold slots 30. The plurality of mold slots 30 may extend linearly and in the lateral direction the same or a similar distance that the energy absorption bracket 22 extends linearly in the lateral direction. The inner surface 24 of the trim cover 16 may interface the convex surface 34 of the energy absorption bracket 22.

Accordingly, a vehicle 12 having a trim assembly 10 having an inserted molded energy absorption bracket 22 within the trim cover 16 is provided for neat assembly of the bracket and trim cover simultaneously. The insert molded bracket advantageously provides for a neat and uncluttered trim assembly.

It is to be understood that variations and modifications can be made on the aforementioned structure without departing from the concepts of the present invention, and further it is to be understood that such concepts are intended to be covered by the following claims unless these claims by their language expressly state otherwise.

1. A trim assembly for a vehicle, the trim assembly comprising:
a tube;
a trim cover coupled with the tube, wherein an inner surface of the trim cover defines recessed grooves;
an air curtain disposed between the tube and the trim cover; and
a bracket insert molded into the trim cover, wherein the bracket is spaced from the tube and the air curtain.

2. The trim assembly of claim 1, wherein the trim cover further comprises:
an inner surface; and
an outer surface, wherein the bracket is insert molded between the inner surface and the outer surface.

3. The trim assembly of claim 1, wherein the trim cover is concave toward the tube, and wherein the bracket is concave toward the tube.

4. The trim assembly of claim 1, wherein the trim assembly operates between an original position, a flattened position, and a deployed position.

5. The trim assembly of claim 1, wherein the trim cover is made from a polymeric material, wherein the bracket is made from a first metal material, and wherein the tube is made from a second metal material.

6. The trim assembly of claim 1, wherein the bracket extends linearly in a lateral direction, and wherein the bracket extends curvedly in a vertical direction.

7. The trim assembly of claim 1, wherein the bracket is partially exposed between the trim cover and the tube.

8. The trim assembly of claim 1, wherein the trim cover further comprises a plurality of mold slots, and wherein a peripheral edge of the bracket is insert molded into the plurality of mold slots.

9. The trim assembly of claim 8, wherein the peripheral edge of the bracket is partially exposed between the plurality of mold slots.

10. The trim assembly of claim 8, wherein the plurality of mold slots protrudes from the trim cover toward the tube in an original position and a flattened position.

11. The trim assembly of claim 8, wherein a convex surface of the bracket interfaces with an inner surface of the trim cover.

12. The trim assembly of claim 1, wherein the trim cover further includes:
an upper portion coupled with the tube; and
a lower portion cantilevered from the tube.

13. The trim assembly of claim 1, wherein the air curtain is further disposed between the tube and the bracket and the air curtain is in direct communication with the bracket.

14. The trim assembly of claim 1, wherein the trim cover has a first thickness, wherein the bracket has a second thickness, and wherein the first thickness is greater than the second thickness.

15. A trim assembly for a vehicle, the trim assembly comprising:
a tube;
a trim cover comprising:
an inner surface and an outer surface;
an upper portion coupled with the tube; and
a lower portion;
an energy absorption bracket insert molded into the trim cover, wherein the energy absorption bracket has a convex surface and a concave surface;
an air curtain disposed between the tube and the energy absorption bracket; and
an integrally formed locator disposed on the upper portion of the trim cover that couples the trim cover to the tube, wherein a terminal end of the integrally formed locator is disposed within an interior of the tube.

16. The trim assembly of claim 15, wherein the convex surface and the concave surface are both disposed between the inner surface and the outer surface.

17. The trim assembly of claim 15, wherein the energy absorption bracket is insert molded into the trim cover via at least one mold slot.

18. The trim assembly of claim 15, wherein the trim cover has a first thickness, wherein the bracket has a second thickness, and wherein the first thickness is greater than the second thickness.

19. A trim assembly for a vehicle, the trim assembly comprising:
a tube that defines a frame of the vehicle;
a trim cover comprising:
an inner surface concave toward the tube;
an outer surface convex toward an interior of the vehicle;
an upper portion, wherein the upper portion is coupled with the tube; and
a lower portion, wherein the lower portion is cantilevered from the tube, and extends substantially parallel to a bottom side of the tube; and
an energy absorption bracket insert molded into the trim cover, the energy absorption bracket comprising:
a concave surface facing the tube, wherein the concave surface is at least partially covered by the trim cover;
a convex surface facing the interior of the vehicle, wherein the convex surface is at least partially covered by the trim cover; and
a peripheral edge; and
an air curtain disposed between the energy absorption bracket and the tube.

20. The trim assembly of claim 19, wherein the trim cover further comprises:
mold slots protruding toward the tube, wherein the peripheral edge of the energy absorption bracket is insert molded into the mold slots, and the bracket is at least partially exposed to the air curtain and the tube.
